(19) United States
(12) Patent Application Publication
(10) Pub. No.: US 2006/0280824 A1
(43) Pub. Date: Dec. 14, 2006

(54) Glass repairer

(76) Inventor: Chi-Tsai Chang, Taichung City (TW)

Correspondence Address: LEONG C LEI, PMB # 1008, 1867 YGNACIO VALLEY ROAD, WALNUT CREEK, CA, 94598, US

(21) Appl. No.: 11/148,252

(22) Filed: Jun. 9, 2005

(51) Int. Cl. B32B 35/00

(52) U.S. Cl. 425/13

(57) ABSTRACT

A glass repairer for summary repair of crack developed on the surface of a piece of glass is comprised of a positioning fixture adapted with a sucker each on both sides, a center hole to lock up an injection pipe containing repair liquid with its root to directly contact the crack with a rubber retaining ring and flushed against the surface of the glass with a packing packed to the root of the pipe to push against the surface of the glass in opposite direction; and a rotary extrusion device disposed at the top of the pipe to deliver the repair liquid.

### BACKGROUND OF THE INVENTION

(a) Technical Field of the Invention

The present invention is related to a glass repairer, and more particularly, to one that allows easy assembly and gives properly elastic buffer to squeeze for delivering material to repair crack on glass, thus to effectively contain further damage of cracking to the glass.

(b) Description of the Prior Art

When a piece of glass develops crack due to impacts, the crack may grow and eventually the glass is shattered if the crack has not properly caulked. For any crack developed, replacement with a new piece is a better option for safety concerns. However, in case of a larger and thicker piece of glass, replacement is not so convenient and the cost is very expensive to cause a heavy burden to the user. Taking the windshield of a car for example, the replacement is cost. Doubts over the driving safety, leak proof, and silence may present due to any act of omission during the replacement since size and specification do vary depending on the model of the car. Therefore, crack developed on the windshield after minor impact is usually repaired by adhesion of resin without compromising drive safety. A DIY windshield repairer has been developed as taught in Taiwan Utility Patent Application No. 84208008 titled “Windshield Glazing Repairer. The prior art is essentially comprised of a hollow pressure barrel having its one end screwed to a base and a rotary lever locked to the inner side at the center of the barrel. Accordingly, when the barrel is downwardly turned, the bottom of the lever sticks into a central hole of a stopper to extrude a repair liquid. However, the design of the prior features repair at a specific point. The extrusion consumes a lot of efforts since the repair liquid is done by forthwith turning the treads. Furthermore, the pressure exerted to extrude is not necessarily the same to prevent caulking fine cracks.

### SUMMARY OF THE INVENTION

The primary purpose of the present invention is to provide an improved construction of a glass repairer to eliminate those flaws found with those glass repairers generally available in the market. To achieve the purpose, the present invention features a simple positioning fixture, a central lockup unit containing a liquid storage pipe to extrude the repair liquid, and an elastic buffer device disposed at the top to provide easy extrusion of repair liquid. Wherein, suckers are provided to both sides of the positioning fixture and the liquid storage pipe is locked through the center of the positioning fixture to deliver the repair liquid at a constant pressure with the aid of the buffer.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a preferred embodiment of the present invention.

FIG. 2 is a perspective view of the preferred embodiment of the present invention.

FIG. 3 is a schematic view showing the preferred embodiment of the present invention in use.

FIG. 4 is a schematic view showing the operation of a positioning unit of the preferred embodiment of the present invention.

FIG. 5 is a schematic view showing the extrusion of a repair liquid by the preferred embodiment of the present invention.

Attachment: a photocopy of Gazette (Taiwan) showing an application #84208008 of “Windshield Glazing Repairer”.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

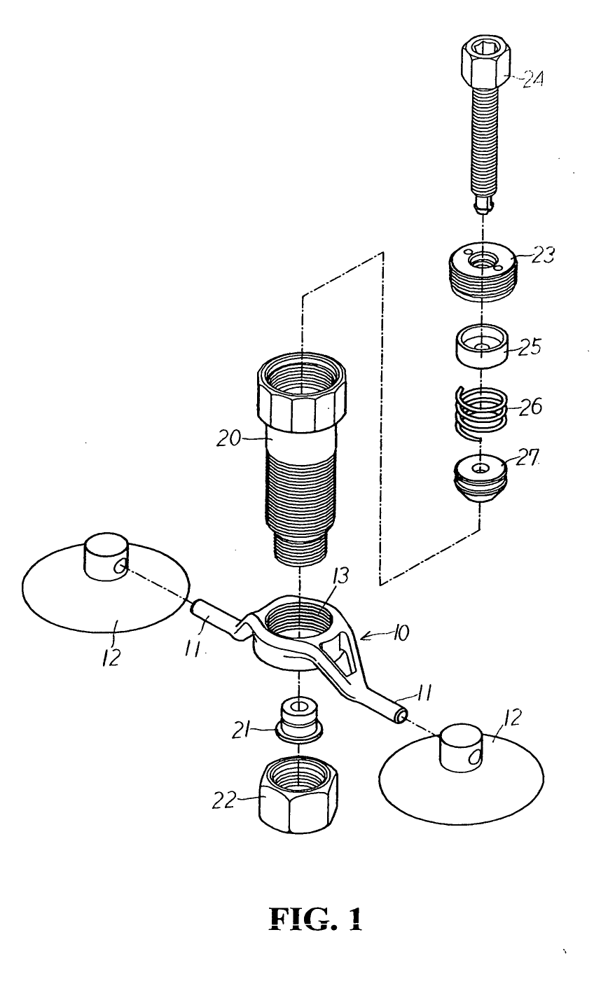

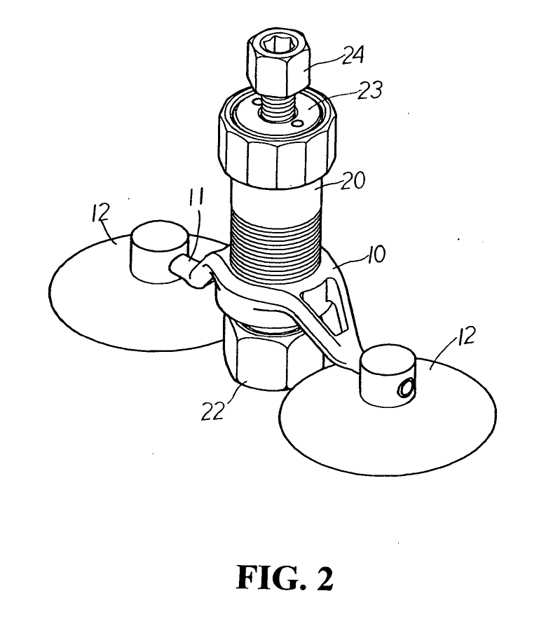

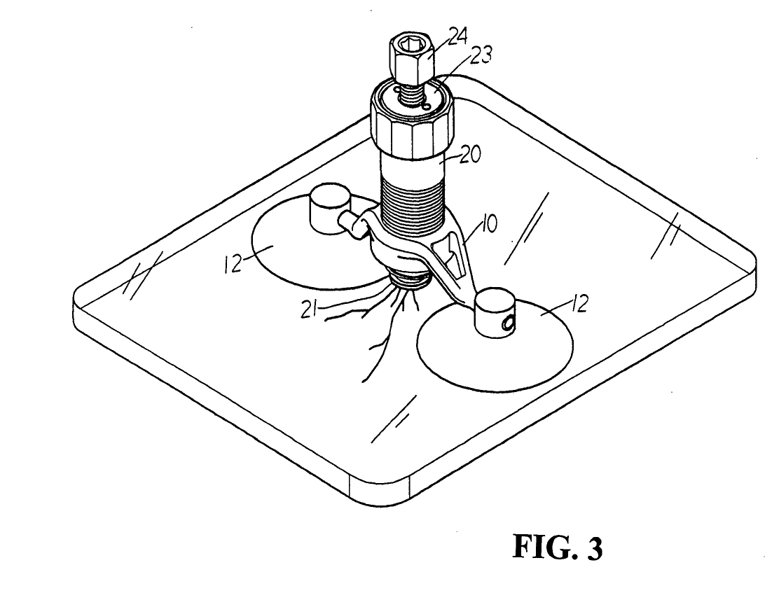

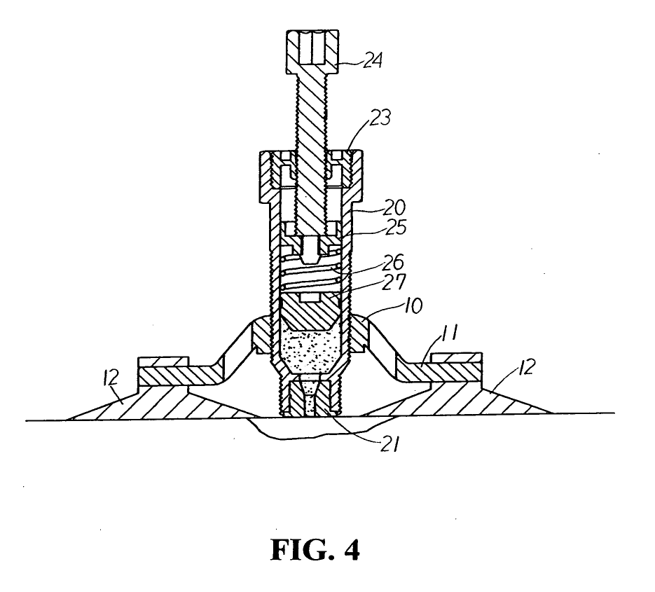

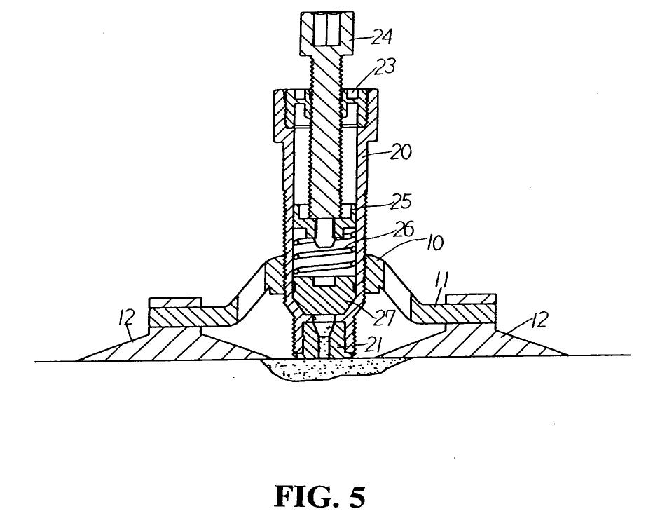

Referring to FIGS. 1 through 5, a preferred embodiment of the present invention for a glass repairer construction is essentially comprised of a positioning fixture (10) and a hollow pipe (20). The positioning fixture (10) is provided with two levers (11) respectively extending from both sides, and the distal end of the lever (11) may be made in a hook form to facilitate insertion of a sucker (12). The summary construction of the positioning fixture (10) provides a mobile pivoting fixture for easy assembly and control. A threaded hole (13) is provided at the center of the positioning fixture (10) to secure the pipe (20) containing a repair liquid. The pipe (20) is externally threaded to directly lock into the central hole (13) to complete a cross cut assembly to the positioning fixture (10). A resilient retaining ring (21) mounted to an outlet at the root of the pipe (20) directly holds against the surface of a piece of glass. Upon filling up the pipe (20) with the repair liquid, the root of the pipe (20) is locked up with a blind nut (22) to prevent escape of the repair liquid. The nut (22) is removed only upon commencing the repair job for the retaining ring (21) to directly touch the glass surface where a crack is developed. A graded circumference in larger diameter than that of the pipe (20) is provided inside the top of the pipe (20) to be locked up with a plug (23). By compromising the extrusion of the repair liquid in the tube (20), an extrusion press bolt (24) is secured in position with an end ring (25) after the installation of the plug (23), a coil (26), and an extrusion end piece (27) in sequence to constitute a complete extrusion unit. As secured in position by the plug (23), the extrusion of the repair liquid by rotation is held steady. The coil (26) stores energy when subject to compression before pushing the end piece (27) to slow down the extrusion at a consistent pressure for the delivery of the repair liquid to maintain stable pressure in injection to repair. The threaded shaft of the press bolt (24) provides piston type of rotation to press the repair liquid to flow down to the end of the pipe (2) and into the crack to complete the repair job.

Two suckers (12) disposed to both sides of the positioning fixture (10) achieve summary positioning purpose by suction. In conjunction with the insertion of the pipe (20) through the central hole (13) of the positioning fixture (10), the press bolt (24) is turned to squeeze as buffered by the coil (26) to secure a consistent and reliable delivery of the repair liquid. The location of the pipe (20) through the automatic pivoting design of the positioning fixture (10) makes the entire pipe (20) to maintain practically vertical to the surface of the glass for achieving the safe and reliable delivery of the repair liquid.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A glass repairer is essentially comprised of a positioning fixture and a hollow pipe; the positioning fixture allowing mobile pivoting by extending from its both sides each a lever attached with a sucker; a repair liquid being filled into the pipe; a threaded hole being disposed at the center of the positioning fixture; the pipe being inserted into the central hole to be directly secured and holding against a crack developed on the surface of a piece of glass; a graded circumference in diameter greater than that of the pipe being provided at the top of the pipe and locked up with a press bolt; the entire pipe after penetrating through the central hole of the positioning fixture being locked in position by a retaining ring; and the repair liquid being extruded out of the pipe by turning the press bolt and buffered by a coil mounted in the pipe.

2. The glass repairer of claim 1, wherein a blind nut is provided externally to the out end of the root of the pipe to prevent escape of the repair liquid.

3. The glass repairer of claim 1, wherein a resilient retaining ring is inserted into the root of the pipe to secure airtight status with the surface of the glass.

4. The glass repairer of claim 1, wherein the distal end each lever extending from the positioning fixture is made in the form of a hook.
